(19) United States
(12) Patent Application Publication
(10) Pub. No.: US 2006/0042514 A1
(43) Pub. Date: Mar. 2, 2006

(54) Agglomerated waste expanded perlite

(76) Inventors: Frederick M. Bodycomb, Springfield, CO (US); Charles S. Smith, Hudson, OH (US)

Correspondence Address: Timothy B. Smith;Suite 1300, 185 South State Street, Salt Lake City, UT, 84111, US

(21) Appl. No.: 11/233,957

(22) Filed: Sep. 23, 2005

Related U.S. Application Data
(63) Continuation-in-part of application No. 10/930,068, filed on Aug. 30, 2004.

(51) Int. Cl. C04B 20/00

(52) U.S. Cl. 106/675

(57) ABSTRACT

Perlite, a volcanic glass, is used in a variety of horticultural, construction and industrial applications. In order to be put to such uses, mined perlite ore is crushed and screened to size and then expanded by being passed through a flame at high temperature. During the expansion phase, up to 50% of the perlite may be unintentionally fractured, resulting in very fine perlite material with little or no commercial application. The method and product of the present invention converts waste perlite material, which is of such a size and quality that it is of no value to a manufacturer and is difficult to dispose of, into a relatively dust free product with numerous end applications, some of which are new uses for perlite.

### RELATED APPLICATION

This application is a continuation-in-part of Ser. No. 10/930,068 filed Aug. 30, 2004, now pending, by the inventors hereof, under the title “Agglomerated Perlite.”

### FIELD OF THE INVENTION

The present invention relates to methods of agglomeration and use of waste expanded perlite presently not saleable or useable.

### BACKGROUND OF THE INVENTION

Expanded perlite is used in a variety of horticultural, construction and industrial applications. Perlite is a naturally occurring hydrated volcanic glass formed by the alteration of obsidian. Typically, perlite is composed of silicon dioxide (72-75%), alumina (12-14%), iron oxide (approximately 1%), as well as compounds of calcium, potassium, sodium, titanium, and other elements (all in quantities of less than 5%). In order to obtain expanded perlite, crude perlite ore is mined, crushed, dried in a rotary dryer, milled, sized (usually by screening), and shipped to expansion plants. The sized perlite is expanded in order to obtain very low density frothy bubbles in the material. Expansion is accomplished because of the presence of two to six percent combined water in the crude perlite rock. When quickly heated to above 870° C. (1598° F.), the crude milled rock pops in a manner similar to popcorn as the glassy ore particles soften in the flame while the combined water in the ore turns to steam and expands forming the numerous low density bubbles mentioned previously.

During the expansion process, fine, small particle expanded perlite is unavoidably produced. These small particles must be separated from the coarser end product and are a waste material of no commercial value. The waste material is primarily of a fine material and is separated out in a cyclone during the expansion process. Being a waste product, the waste expanded perlite varies in size. It is primarily −100 mesh and typically contains a large percentage of −200 mesh. This waste expanded perlite is unsaleable, and is difficult, if not impossible to discard. Consequently, huge quantities of this waste expanded perlite have accumulated, and continue to accumulate, in storage facilities located at most perlite expansion plants throughout the United States.

The advantages of using expanded perlite are well known. It is very lightweight, has exceptional moisture absorption and retention capabilities and outstanding insulating characteristics. In construction, expanded perlite is widely used as loose fill insulation in masonry construction. Expanded perlite is poured into the cavities within the masonry block and provides thermal insulation, acoustical insulation, enhanced fire and rot resistance. Perlite can also be used as an aggregate in Portland cement concrete, and is used in Portland cement and gypsum plasters, ceiling tile, insulating board, etc. resulting in low density, fire-resistant products.

Additionally, large particle sized expanded perlite is used for a variety of horticultural purposes, primarily as an additive to soils. In this capacity, it provides aeration and moisture retention to aid in superior plant growth. A wide range of mixture ratios can be used with perlite. In some instances, a small amount of perlite is added to soil, while in others, 100% perlite is utilized, such as when used for hydroponic plantings. Expanded perlite is weed-free and can be used as a carrier for fertilizer, herbicides, pesticides and seeds. In horticultural applications, expanded perlite is used in everything from house plants to large commercial greenhouses to golf courses.

Finally, expanded perlite has many industrial applications. It can be used as a filler in plastics, as an additive to cement used in the drilling of oil, gas, water and geothermal wells, or as filter material for the clarification of pharmaceuticals, beverages, chemicals, water, etc. Nevertheless, while there are numerous uses for expanded perlite, there are essentially no uses for the waste expanded perlite that remains after the expansion process.

There are several varieties of perlite ore. The two primary types of perlite ore used commercially are “granular,” and classical “onion-skin.” While expanded ore fines produced from certain classical types may be valuable for use as a filter aid, fines produced from granular types are usually of little or no commercial value. Pelletization of waste expanded perlite from expanded granular ore would, therefore, be of greater utility. It is the intent of this patent, however, to include the agglomeration of expanded waste material from both types of perlite.

During the expansion process, some very small bubbles are produced, and unintended and unwanted fracturing of the perlite occurs, resulting in the production of waste expanded perlite. The waste expanded perlite is removed from the expanded perlite in a cyclone and collected in a baghouse. Up to 50% of the material introduced to the expansion process may end up as waste. A small amount of the resulting waste, if of the right size and quality, may be used in insulations and fine plasters. Most of the waste material, however, has no commercial use. It is also costly to store and dispose of the essentially unusable and worthless waste expanded perlite.

Accordingly, there is a need to utilize the massive amounts of this otherwise unusable waste expanded perlite that is accumulating in or near perlite expansion facilities. There is also a need for material that possesses the properties of saleable expanded perlite in a less dusty form. Expanded perlite can be extremely dusty, limiting possible applications of the product. There is therefore also a need for a relatively dust-free expanded perlite product.

### SUMMARY OF THE INVENTION

The present invention provides a solution to existing needs as well as many others. By agglomerating presently unusable waste expanded perlite, a new perlite product is created. This is of particular use in converting fine waste expanded perlite into valuable, large-particle horticultural grades. The waste expanded perlite that would otherwise be discarded can be made into a useful product of varying sizes ranging from less than ⅛″ to more than 1″, while at the same time the supply of material with commercially valuable expanded perlite qualities is increased.

New uses are possible for the relatively dust-free agglomerated waste expanded perlite. One such new use is for “cavity fill” insulation in such areas as between joists in attics and between studs in walls. Expanded perlite as now sold is too dusty to be used in such areas. The new product discussed herein is an agglomerated relatively dust-free waste perlite in granular or pellet form that would be ideal for such applications. Such perlite agglomerates might also contain a fungicide to inhibit mold growth.

A second new use for smaller diameter agglomerated waste perlite would be for cryogenic insulation. Vibration would not cause the agglomerated particles to settle in the cavity of a container or vessel to the extent that loose, small-particle perlite, which is currently in use, settles.

A third new use for agglomerated waste perlite would be for aerial reseeding of fire-burned areas, or areas that require seeding due to inadequate natural seed production, or otherwise denuded areas. Present reseeding in slurry or dry form are susceptible to blowing from wind and have other serious drawbacks. Use of seeds, with fertilizer, etc. in a perlite pellet form allows for more accurate placement from an aircraft, permits seeding to proceed in windier conditions, and has other benefits.

A fourth new use would be to allow the use of fine waste expanded perlite for horticultural purposes that would otherwise require large particle size perlite, simply by agglomerating the fine waste perlite to the appropriate size.

An additional new use for agglomerated waste expanded perlite would be as an absorbent material in stockyards and as poultry litter. When the area(s) so treated are cleaned out, the mixture of manure and perlite could be more useful when applied to agricultural land than manure alone.

Other new uses will become evident as the production of agglomerated waste expanded perlite becomes established.

It is an object of the invention to provide a commercially valuable waste expanded perlite agglomerate that retains qualities similar to those of expanded perlite (as presently produced), in a relatively dust-free form.

It is a further object of the invention to provide a perlite agglomerate that uses waste expanded perlite, which would otherwise be discarded, to serve as a replacement for more expensive expanded perlite.

According to one aspect of the invention, agglomerated waste expanded perlite may be used for new applications such as aerial reseeding and new cavity fill insulation markets for which loose and dusty expanded perlite as now produced is not useable.

According to another aspect of the invention, an expanded perlite product, comprised of waste expanded perlite and a binder is produced. The waste expanded perlite agglomerates are produced by an agglomeration process. The agglomeration process uses a tumble/agitative agglomeration method, such as a pelletizing disc or granulating drum. The waste perlite may be formed into a sheet, like paper or cardboard, dried and crushed to form flakes. However, a pressure method, an extrusion method, a pelletizing method, or other agglomeration technology or methods may be used. It is an object of the present invention for the tumble/agitative agglomeration technology to comprise tumbling, mixing, granulation, balling, pressing, sheeting or conditioning.

According to another aspect of the invention, the waste expanded perlite agglomerate comprises waste expanded perlite and a binder or binders, including but not limited to: liquids, waste liquids, waste liquid/solid mixtures, liquid fertilizers, starches; adhesives; polymers; fibers, including cellulose, macerated fabrics, cotton, wool, and polymeric fibers; gypsum; and lime; and/or a combination of same.

According to another aspect of the invention, the waste expanded perlite agglomerate that possesses the outstanding aeration and moisture retention features of expanded perlite may also comprise seeds and/or fertilizer, insecticides, herbicides, etc., as required, for horticultural/agricultural markets.

According to another aspect of the invention, an agglomerated/pelletized waste expanded perlite product may be used as a seed delivery system that is produced by either a tumble/agitative, pressure, extrusion, pelletizing, or other agglomeration technology or method. The term agglomeration relates to particle size enlargement. A fertilizer, herbicide, or pesticide may be added to the waste expanded perlite agglomerate of the present invention, as desired.

Another aspect of the invention is to use an agglomerated/pelletized waste expanded perlite product as a seed delivery system that is relatively resistant to wind dispersal or bird or animal consumption.

Another aspect of the invention is to provide an agglomerated waste expanded perlite product that can be used for loose/cavity fill thermal insulation.

Another aspect of the invention is to provide an agglomerated waste expanded perlite product that can be added to concrete, Portland cement and gypsum plasters resulting in a lightweight fire-resistant product.

Another aspect of the invention is to provide an agglomerated waste expanded perlite product that can be used as a filler in plastic, as an additive to cement used in the drilling of petroleum, water and geothermal wells, or as filter material for pharmaceuticals, chemicals, water, or other fluids.

These and other features and advantages of the preferred embodiment of the present invention will become apparent from the detailed description of the invention.

### DETAILED DESCRIPTION OF THE INVENTION

One embodiment of the present invention is the method of making waste expanded perlite in relatively dust-free agglomerated, pelletized, flaked or granulated form. An agglomerate is defined as an assemblage of particles, which is either loosely or rigidly joined together, with several particles adhering to each other. While agglomeration may be accomplished through several different existing technologies, the inventors are unaware of any of those technologies having been applied to the agglomeration of waste expanded perlite. An agglomerated waste perlite product may be used as an additive to soils to absorb moisture thus increasing the moisture-holding capacity of the soil, reducing the rate of evaporation and enhancing the retention of moisture in the soil making additional water available to plants over an extended period of time. The agglomerated waste perlite also has many of the same qualities as more expensive expanded perlite and can be used in many of the same construction and industrial purposes as expanded perlite that are discussed above.

Waste expanded perlite is combined with a binder or binders to facilitate the formation of pellets. Numerous additives could be used as binders, including but not limited to, liquids, waste liquids, waste liquid/solid mixtures, liquid fertilizers; starches; adhesives; polymers; fibers, including cellulose, macerated fabrics, cotton, and polymeric fibers.

In a preferred embodiment, unsaleable waste expanded perlite is mixed with pulped cellulose, corn starch and water. Mixers such as pin mixers, paddle mixers or other types of mixers can be used. Other materials may also be added to the mixture including, but not limited to, fertilizer, insecticides, herbicides, and/or seeds. When using the agglomerated waste perlite in a horticultural or agricultural use, it may be advantageous to use biodegradable materials in the agglomeration process in order to facilitate the disintegration of the agglomerate and its dispersement into the soil. The mixture is then agglomerated in an agglomeration process.

The agglomeration performed to create the agglomerated waste perlite is done by either a tumbling/agitation method, such as a pelletizing disc or granulating drum for lower density applications; a pressure method, such as briquetting for higher density applications, tableting and/or pressing; an extrusion method; a pelletizing method, such as pelletizing discs; or other agglomeration technology or methods.

An example of how the waste expanded perlite can be agglomerated with pressure technology is described below.

A combination of 80% waste expanded perlite, 10% pulped newsprint (fiberized in a blender), 10% corn starch and water (3 times the weight of the dry constituents added with the starch and 0.3 times the weight of the dry constituents added with the pulped newsprint) is mixed by hand. The mixture is then inserted into a cylinder that is closed on one end. Pressure is applied to the mixture through the use of a rod of slightly smaller diameter than the inside diameter of the cylinder that is inserted into the cylinder. This causes the mixture to compress into a strong expanded perlite agglomerate. The pellets are then dried.

In a preferred embodiment, the waste expanded perlite agglomerate of the present invention has the following characteristics: relatively dust free; easily handled/transported; rapid and easy cleanup if spilled, and waste-free.

Use as a Seed Delivery System

When seeds are included in the mixture of waste expanded perlite, cellulose, corn starch and water, the resulting agglomerate can serve as an optimal seed delivery system. It is well known that expanded perlite provides exceptional aeration and moisture retention qualities that aid in superior plant growth. When a seed is included in a waste expanded perlite agglomerate, it is automatically placed in ideal growing conditions. If fertilizer is also included in the waste expanded perlite agglomerate, the growing conditions become even better. Additionally, because the seeds are encased in the waste expanded perlite agglomerate, there is less likelihood that the seeds will be eaten by birds or other animals, again increasing the probability of successful seed germination. Because waste expanded perlite can be agglomerated to particles of varying size and weight, a waste expanded perlite agglomerate also provides for more precise placement of the seeds contained therein and ensures that the seed will not be as easily scattered by wind or rain. Finally, the waste expanded perlite agglomerate can be manufactured in such a way that a precise desired ratio of seed/fertilizer is obtained without requiring the end user to worry about such ratios.

Use in Industrial Applications

The agglomerated waste expanded perlite product, which does not contain seed, fertilizer, etc., possesses similar qualities as expanded perlite that make it suitable for many industrial purposes. Certain binders, such as gypsum, lime, various polymers and adhesives, can be utilized to prevent any degradation of the agglomerated waste expanded perlite product so that it can be used, for example, as a filler in plastics or as an aggregate with cement used in light weight concrete, or in the drilling of petroleum, water and geothermal wells. The use of waste expanded perlite in the agglomeration process for industrial applications can also lead to substantially reduced costs as well as the utilization of what would otherwise be a waste product.

Use in Construction Applications

Similarly, the agglomerated waste expanded perlite product, which does not contain seed, fertilizer, etc., possesses similar qualities as expanded perlite that make it suitable for several construction applications. As such, the agglomerated waste expanded perlite product can be used as an aggregate in concrete, and Portland cement and gypsum plasters resulting in lightweight fire-resistant products. A major use might be as cavity fill thermal insulation. Again, the use of agglomerated waste expanded perlite can lead to substantially reduced costs as well as the utilization of what would otherwise be a waste product.

The description of the invention above should not be interpreted as limiting the invention to the disclosed embodiment because those who are skilled in the art to which the invention relates will be able to devise other equivalent forms thereof within the scope of the invention. Variations and changes, which are obvious to one skilled in the art, are intended to be within the scope and nature of the present invention. This would include coating the pellets or granules for certain uses, and agglomerating waste expanded perlite with varying amounts of otherwise saleable expanded perlite.

What is claimed is:

1. A method of agglomerating waste expanded perlite comprising:
obtaining waste expanded perlite;
combining said waste expanded perlite and a binder; and
agglomerating said waste expanded perlite and binder mixture to produce agglomerated waste expanded perlite having the properties of expanded perlite.

2. The method of claim 1, wherein the step of agglomerating is by use of an agglomeration technology selected from a group consisting essentially of tumble, agitative, pressure, extrusion and pelletizing agglomeration technologies.

3. The method of claim 1, wherein the binder is selected from a group consisting essentially of liquids, waste liquids, waste liquid/solids, liquid fertilizers, starches, adhesives, polymers, fibers, cellulose, newsprint, macerated fabrics, cotton, gypsum, lime, and polymeric fibers.

4. The method of claim 1 further comprising: adding seed selected from a group of grass, tree, shrub and other vegetation seed.

5. The method of claim 4 further comprising: adding fertilizer or a germination enhancer.

6. The method of claim 5, wherein the germination enhancer is a butenolide.

7. The method of claim 5 further comprising: adding an additive selected from a group consisting of pesticide, insecticide, fungicide, herbicide and rodenticide.

8. A method of agglomerating waste expanded perlite, the method comprising producing expanded perlite with a by-product of waste expanded perlite, separating the expanded perlite from the waste expanded perlite so that the expanded perlite is useable in commercial applications, and collecting the waste expanded perlite, wherein the improvement comprises, combining the waste expanded perlite with a binder and agglomerating the waste expanded perlite into a useable agglomerate.

9. The method of claim 8, wherein the step of agglomerating is by use of an agglomeration technology selected from a group consisting essentially of tumble, agitative, pressure, extrusion and pelletizing agglomeration technologies.

10. The method of claim 8, wherein the binder is selected from a group consisting essentially of liquids, waste liquids, waste liquid/solids, liquid fertilizers, starches, adhesives, polymers, fibers, cellulose, newsprint, macerated fabrics, cotton, gypsum, lime, and polymeric fibers.

11. The method of claim 8 further comprising: adding seed selected from a group of grass, tree, shrub and other vegetation seed.

12. The method of claim 11 further comprising: adding fertilizer or a germination enhancer.

13. The method of claim 12, wherein the germination enhancer is a butenolide.

14. The method of claim 12 further comprising: adding an additive selected from a group consisting of pesticide, insecticide, fungicide, herbicide and rodenticide.

15. An agglomerated waste expanded perlite product comprising waste expanded perlite and a binder.

16. The agglomerated waste expanded perlite product of claim 15, wherein the binder is selected from a group consisting essentially of liquids, waste liquids, waste liquid/solids, liquid fertilizers, starches, adhesives, polymers, fibers, cellulose, newsprint, macerated fabrics, cotton, gypsum, lime, and polymeric fibers

17. The agglomerated waste expanded perlite product of claim 15 further comprising: seed selected from a group of grass, tree, shrub and other vegetation seed.

18. The agglomerated waste expanded perlite product of claim 17 further comprising fertilizer or a germination enhancer.

19. The agglomerated waste expanded perlite of claim 18, wherein the germination enhancer is a butenolide.

20. The agglomerated waste expanded perlite product of claim 18 further comprising a additive selected from a group of pesticide, insecticide, fungicide, herbicide and rodenticide.
